(19) United States
(12) Patent Application Publication
(10) Pub. No.: US 2020/0073935 A1
(43) Pub. Date: Mar. 5, 2020

(54) GENERATING INSTRUCTIONAL VARIANTS BASED ON NATURAL LANGUAGE PROCESSING OF COMMENTS FEED

(71) Applicant: INTERNATIONAL BUSINESS MACHINES CORPORATION, ARMONK, NY (US)

(72) Inventors: Kevin D. Hite, Morgan Hill, CA (US); Richard V. Tran, San Jose, CA (US)

(21) Appl. No.: 16/118,867

(22) Filed: Aug. 31, 2018

(51) Int. Cl. G06F 17/27; G06N 99/00; G06N 5/04; G09B 19/00

(52) U.S. Cl. CPC G06F 17/2765; G09B 19/0092; G06N 5/04; G06N 99/005

(57) ABSTRACT

A method, computer system, and a computer program product for generating an instructional variant is provided. The present invention may include identifying an instructional guide. The present invention may also include analyzing a user comments feed associated with the identified instructional guide. The present invention may further include, in response to determining that the analyzed user comments feed includes a modification to the identified instructional guide, generating a variant instructional guide including the modification to the identified instructional guide.

### BACKGROUND

The present invention relates generally to the field of computing, and more particularly to cognitive computing.

Many websites that provide instructional guides (e.g., recipes, user guides, how-to manuals) allow users to submit comments pertaining to the user experiences with following the instructional guides. The submitted user comments for an instructional guide may include experience-based insights (e.g., recommendations, helpful tips, and alternative steps/tools/ingredients) which may be beneficial to new users looking to follow the instructional guide. However, reading through the user comments feed is a tedious process for new users trying to quickly learn more about the instructional information provided in the instructional guide.

### SUMMARY

Embodiments of the present invention disclose a method, computer system, and a computer program product for generating an instructional variant. The present invention may include identifying an instructional guide. The present invention may also include analyzing a user comments feed associated with the identified instructional guide. The present invention may further include, in response to determining that the analyzed user comments feed includes a modification to the identified instructional guide, generating a variant instructional guide including the modification to the identified instructional guide.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for generating instructional variants according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for generating instructional variants for an instructional guide based on natural language processing of a user comments feed. As such, the present embodiment has the capacity to improve the technical field of cognitive computing by crowd-sourcing modifications to an instructional guide (e.g., a recipe) based on natural language processing of the user comments and generating instructional variants for the instructional guide based on the crowd-sourced information. More specifically, an instructional guide may be identified by a variant generating program on a webpage. The variant generating program may scan a user comments feed and extract the user comments pertaining to the instructional guide. Then, the variant generating program may analyze the user comments with natural language processing to determine if the user comments include modifications to improve the instructional information of the instructional guide. For example, the variant generating program may analyze the user comments associated with a recipe to determine favorable ingredient substitution. In another example, the variant generating program may analyze the user comments associated with a technical user guide or how-to manual to determine favorable ordering of steps, tools used, and helpful tips/hints. If the variant generating program determines that the user comments include modifications to the instructional information of the instructional guide, the variant generating program may generate a variant instructional guide based on the determined, crowd-sourced modifications. Thereafter, the variant generating program may display the variant instructional guide to an end-user.

As described previously, many websites that provide instructional guides (e.g., recipes, user guides, how-to manuals) allow users to submit comments pertaining to the user experiences with following the instructional guides. The submitted user comments for an instructional guide may include experience-based insights (e.g., recommendations, helpful tips, and alternative steps/tools/ingredients) which may be beneficial to new users looking to follow the instructional guide. However, reading through the user comments feed is a tedious process for new users trying to quickly learn more about the instructional information provided in the instructional guide.

When the provided instructional guides are recipes, some websites provide recipes based on a set of ingredients selected by an end-user. However, these websites are limited to providing the recipes that are manually recorded in a recipe database of the website and are not enabled to provide variants on a given recipe. Other websites provide multiple recipes for a specific food dish searched for by the end-user. However, the variations in the multiple recipes provided by these websites often lead to substantially different food dishes. As such, an end-user would have to read through the user comments feed for a given recipe to find recipe variants and alternative suggestions, such as, cook time and ingredient substitutions/additions.

Therefore, it may be advantageous to, among other things, provide a way to generate variants to an instructional guide based on an analysis of the user comments associated with the original instructional guide. It may be advantageous to perform natural language processing of the user comments to determine the modifications to the original instructional guide. It may be further advantageous to provide a user-friendly interface, displaying the original instructional guide together with the variant instructional guide.

According to at least one embodiment, the variant generating program may break down a user comment and extract keywords and phrases related to ingredients, cooking methods, time, nutrition, and flavors. In one embodiment, the variant generating program may provide a cognitive assistance component to infer information as to potential ingredient substitutions based on an initial set of information as well as cognitively updated information learned from added recipe variants. In one embodiment, the variant generating program may determine an explicit ingredient substitution. In another embodiment, the variant generating program may determine an inferred quantity substitution. In at least one embodiment, the variant generating program may determine an inferred ingredient and quantity substitution.

According to one embodiment, the variant generating program may provide the cognitive assistance component to infer information as to potential ingredient additions based on an initial set of information as well as cognitively updated information learned from added recipe variants. In another embodiment, the cognitive assistance component may be extended to infer cooking times and methods. In at least one embodiment, the cognitive assistance component may be further extended to vary the number of portions being prepared.

According to at least one embodiment, the variant generating program may provide a nutrition profile for each generated variant recipe. In another embodiment, the variant generating program may migrate the ratings of the user comment into a rating of the variant recipe generated by the user comment. In at least one embodiment, the variant generating program may generate the variant recipe as part of the user comment submission process such that the generated variant recipe and the user comment may be posted on the webpage at the same time.

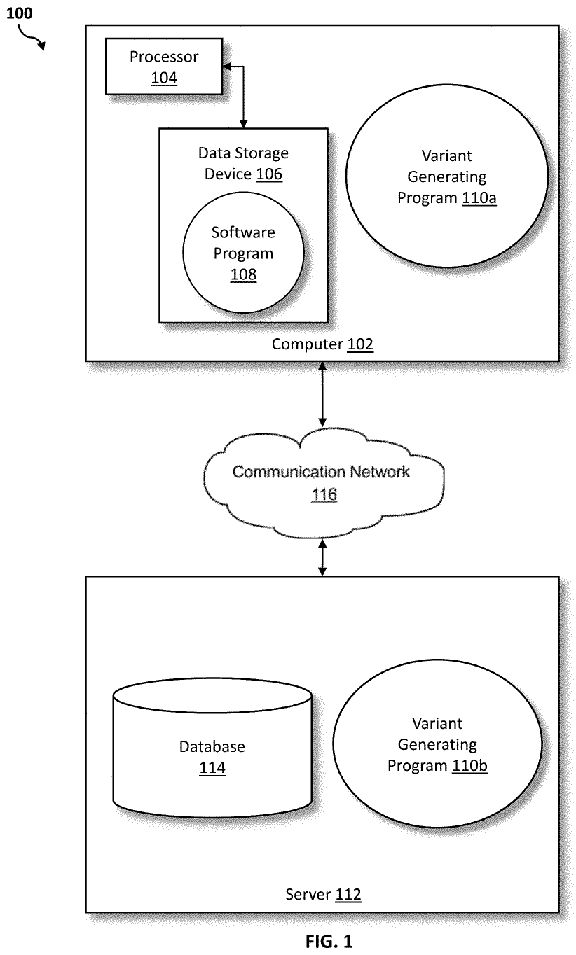

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a variant generating program 110a. The networked computer environment 100 may also include a server 112 that is enabled to run a variant generating program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

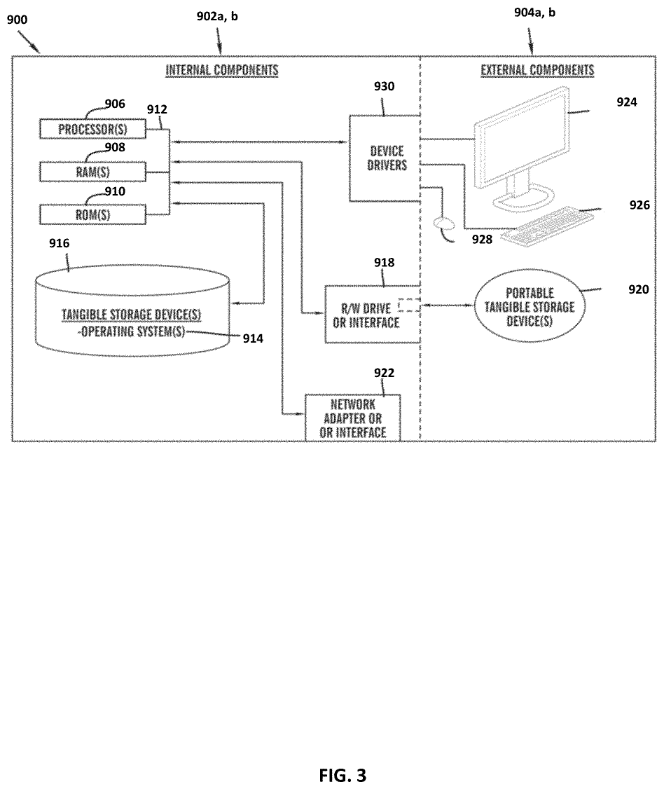

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the variant generating program 110a, 110b may interact with a database 114 that may be embedded in various storage devices, such as, but not limited to a computer/mobile device 102, a networked server 112, or a cloud storage service.

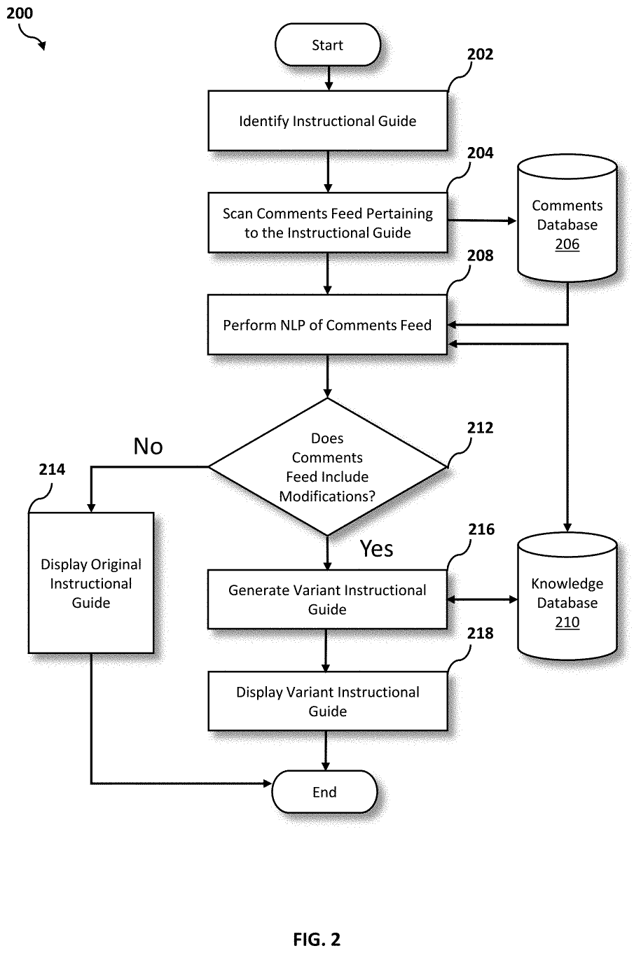

According to the present embodiment, a user using a client computer 102 or a server computer 112 may use the variant generating program 110a, 110b (respectively) to generate instructional variants for an instructional guide based on natural language processing of a user comments feed. The variant generating method is explained in more detail below with respect to FIG. 2.

Referring now to FIG. 2, an operational flowchart illustrating the exemplary instructional variants generating process 200 used by the variant generating program 110a and 110b according to at least one embodiment is depicted.

At 202, an instructional guide is identified. A website, server, or other suitable platform running a variant generating program 110a, 110b may receive (e.g., via communication network 116) a search request for an instructional guide (e.g., a cooking recipe) from a user device of an end-user. The variant generating program 110a, 110b may be provided as an application-programming interface (“API”) or any suitable web tool which may be accessed and implemented by the website. After the website receives the search request from the user device, the website may provide the user device with one or more instructional guides based on the search request. Once the website receives the end-user selected instructional guide from the user device, the variant generating program 110a, 110b may identify the end-user selected instructional guide. In one embodiment, if the website cannot find an instructional guide based on the search request of the end-user, the website may return a search result of zero to the user device and may prompt the end-user to modify the search request.

For example, a cooking website running the variant generating program 110a, 110b as an API is accessed by an end-user interacting with an internet browser on a user laptop. The end-user textually enters a search request for a pancake recipe into a search field provided on the cooking website. The search request is transmitted from the user laptop via communication network 116 and is received by the cooking website. In response, the cooking website provides a list of pancake recipes and the end-user interacts with the user laptop to select one of the provided pancake recipes. The variant generating program 110a, 110b running on the cooking website identifies the pancake recipe selected by the end-user.

Then, at 204, a comments feed pertaining to the instructional guide is scanned. After identifying the instructional guide selected by the end-user, the variant generating program 110a, 110b may scan a user comments feed associated with the instructional guide. The variant generating program 110a, 110b may send a request to the website to locate the user comments feed pertaining to the instructional guide. In one embodiment, the variant generating program 110a, 110b may locate the user comments feed in a portion of a webpage displaying the instructional guide (e.g., a comments section at the bottom of the webpage). In another embodiment, the variant generating program 110a, 110b may locate the user comments feed associated with the instructional guide on a webpage separate from the webpage displaying the instructional guide (e.g., the instructional guide webpage may include a hyperlink to the user comments feed).

In one embodiment, the variant generating program 110a, 110b may include a web scraping component for scraping the user comments feed pertaining to the instructional guide and storing the collected user comments feed in a comments database 206 (e.g., transmitted via communication network 116). In another embodiment, the variant generating program 110a, 110b may include an artificial intelligence component (e.g., computer vision) for identifying the user comments feed on the webpage and extracting the user comments feed pertaining to the instructional guide. The variant generating program 110a, 110b may store the extracted user comments feed in the comments database 206 (i.e., database 114).

Continuing with the previous example, the variant generating program 110a, 110b locates a comments portion on the bottom of the webpage displaying the pancake recipe. Then, the variant generating program 110a, 110b scans the user comments feed with a web scraping component and communicates with the comments database 206, via communication network 116, to store a first user comment (“Great recipe.”) and a second user comment (“The recipe was too sweet for me. I cut down on the sweetness by reducing the sugar by half which worked way better.”) pertaining to the pancake recipe therein.

Then, at 208, natural language processing (NLP) of the comments feed is performed. The variant generating program 110a, 110b may analyze the user comments feed with an NLP component to determine if the user comments feed includes one or more modifications that can be made to the instructional information provided in the instructional guide. In one embodiment, the variant generating program 110a, 110b may communicate with the comments database 206 (e.g., via communication network 116) to retrieve the user comments feed pertaining to the instructional guide. The NLP component of the variant generating program 110a, 110b may perform various tasks (e.g., part-of-speech tagging, tokenizing, and terminology extraction) to identify one or more relevant terms (e.g., relevant for modifications to the instructional guide) from the given corpus of the user comments feed. According to one embodiment, the NLP component may tokenize (e.g., break down) the user comments into chunks and extract keywords and phrases. The NLP component may include linguistic processing to help determine when two or more words may be broken down into a single chunk or token (e.g., “too sweet” as a single token). In one embodiment, the variant generating program 110a, 110b may specify a target (e.g., relevant to modifications to the instructional guide) to be identified by the NLP component in the user comments feed. In at least one embodiment, the variant generating program 110a, 110b may provide a knowledge database 210 (i.e., database 114) including specific terms/words and phrases relevant to the target (e.g., in a recipe, target information related to ingredients, cooking methods, time, nutrition, and flavors). The knowledge database 210 may also include a dictionary/thesaurus to provide additional terms/words that may be related to the target information. The variant generating program 110a, 110b may access the knowledge database 210 when analyzing the user comments feed with the NLP component so that the NLP component may determine (e.g., by comparing with the information stored in the knowledge database 210) if any of the tokens or chunks in the user comments include the specific terms/words and phrases relevant to the target information or are related to the target information.

Continuing with the previous example, the variant generating program 110a, 110b retrieves the first and second user comments from the comments database 206 via communication network 116. Then, the variant generating program 110a, 110b applies the NLP component on the first user comment and breaks down or tokenizes the first user comment into: “great” and “recipe.” Similarly, the variant generating program 110a, 110b applies the NLP component on the second user comment and breaks down or tokenizes the second user comment into: “the,” “recipe,” “was,” “too sweet,” “for,” “me,” “I,” “cut down,” “on,” “the,” “sweetness,” “by,” “reducing,” “the,” “sugar,” “by,” “half,” “which,” “worked,” “way better.” Thereafter, the variant generating program 110a, 110b accesses the knowledge database 210 via communication network 116 and the NLP component learns from the stored information therein that the specific target is terms/words and phrases related to ingredients, cooking methods, time, nutrition, and flavors. Based on learning about the specific target and with access to the dictionary/thesaurus in the knowledge database 210, the NLP component compares the tokens of the first and second user comments against the specific target and identifies the following terms and phrases in the second user comment related to the specific target: “too sweet,” “cut down,” “sweetness,” “reducing,” “sugar,” “half.”

Then, at 212, the variant generating program 110a, 110b determines if the comments feed includes modifications. The variant generating program 110a, 110b may determine whether the user comments feed includes modifications to the instructional information provided in the instructional guide based on the results of the analysis performed by the NLP component at 208.

In one embodiment, the variant generating program 110a, 110b determines that the user comments feed does not include modifications to the instructional guide if, at 208, the NLP component breaks down the user comment and determines that the identified terms and phrases in the user comment are not related to the specific target provided in the knowledge database 210. Continuing with the previous example, if the comments database 206 only includes the first user comment (“Great Recipe.”), the variant generating program 110a, 110b will determine that the first user comment does not include modifications to the instructional guide, based on the break down, by the NLP component at 208, of the first user comment into: “great” and “recipe.”

In another embodiment, the variant generating program 110a, 110b determines that the user comments feed includes modifications to the instructional guide if, at 208, the NLP component breaks down the user comment and identifies terms and phrases that are related to the specific target provided in the knowledge database 210. Continuing with the previous example, if the comments database 206 includes the first user comment and the second user comment, the variant generating program 110a, 110b will determine that the second user comment (“The recipe was too sweet for me. I cut down on the sweetness by reducing the sugar by half which worked way better.”) does include modifications to the instructional guide, based on the break down of the second user comment and the identification of the terms and phrases related to the specific target (“too sweet,” “cut down,” “sweetness,” “reducing,” “sugar,” “half”) by the NLP component at 208.

If the variant generating program 110a, 110b determines that the user comments feed does not include modifications to the instructional guide at 212, then the variant generating program 110a, 110b displays the original instructional guide at 214. In one embodiment, the variant generating program 110a, 110b may return the original instructional guide to the webpage for display to the user device. Accordingly, the webpage may display the instructional guide on the user device with no additional variants to the instructional guide. Continuing with the previous example, the variant generating program 110a, 110b may return the original pancake recipe to the webpage. Then, the webpage may transmit, via communication network 116, the original pancake recipe to the user laptop for display to the end-user with no additional variants to the recipe.

If the variant generating program 110a, 110b determines that the user comments feed does include modifications to the instructional guide at 212, then the variant generating program 110a, 110b generates a variant instructional guide at 216. The variant generating program 110a, 110b may generate the variant instructional guide based on the modifications determined from the user comments feed.

In one embodiment, the variant generating program 110a, 110b may include a cognitive assistance component for processing and comprehending (e.g., via natural language understanding) an initial set of information (e.g., the information in the original instructional guide) and the modifications determined from the user comments feed. The cognitive assistance component may also access the knowledge database 210 (e.g., via communication network 116) and learn from the internal knowledge stored in the knowledge database 210, pertaining to the instructional guide (e.g., general cooking knowledge). Accordingly, the variant generating program 110a, 110b may apply the cognitive assistance component to generate the variant instructional guide, based on the initial set of information, the modifications determined from the user comments feed, and the internal knowledge stored in the knowledge database 210.

Continuing with the previous example, the cognitive component of the variant generating program 110a, 110b comprehends the original pancake recipe and determines that the original pancake recipe calls for one cup of sugar. The cognitive component of the variant generating program 110a, 110b also comprehends, from the break down of the second user comment (“too sweet,” “cut down,” “sweetness,” “reducing,” “sugar,” “half”) by the NLP component, that the modification calls for a recipe where the sugar quantity is reduced by half. Accordingly, the variant generating program 110a, 110b generates a less sweet pancake recipe which calls for a half cup of sugar.

According to one embodiment, the cognitive assistance component of the variant generating program 110a, 110b may determine explicit substitutions in the instructional information, based on comprehension of the original instructional guide and the modifications determined from the user comments feed.

Continuing with the previous example, a user comment states: “I replaced the cup of white sugar with a cup of brown sugar.” Based on the original recipe and the modifications determined from the user comment, the cognitive assistance component of the variant generating program 110a, 110b determines the one-to-one substitution of the white and brown sugar. As such, the variant generating program 110a, 110b generates a variant recipe which replaces the white sugar for one cup of the brown sugar.

According to another embodiment, the cognitive assistance component of the variant generating program 110a, 110b may determine inferred quantity, based on comprehension of the original instructional guide, the modifications determined from the user comments feed, and the internal knowledge stored in the knowledge database 210. In one embodiment, the variant generating program 110a, 110b may update the internal knowledge stored in the knowledge database 210 as more data (e.g., alternative recipes) is received by the variant generating program 110a, 110b.

Continuing with the previous example, for the user comment: “I replaced the white sugar with brown sugar,” the cognitive assistance component of the variant generating program 110a, 110b identifies that a substitution should be made. The cognitive assistance component learns, by accessing the knowledge database 210 via communication network 116, that there is typically a one-to-one ratio of white sugar to brown sugar. The cognitive assistance component then identifies that the original recipe calls for one cup of white sugar and determines that the one cup of white sugar should be replaced with one cup of brown sugar, based on the typical one-to-one ratio of white sugar to brown sugar. If alternative recipes are submitted that substitute white and brown sugar at different ratios, the variant generating program 110a, 110b will update the internal knowledge stored in knowledge database 210 associated with the expected ratio for the sugar substitution.

According to another embodiment, the cognitive assistance component of the variant generating program 110a, 110b may determine inferred ingredient and inferred quantity, based on comprehension of the original instructional guide, the modifications determined from the user comments feed, and the internal knowledge stored in the knowledge database 210.

Continuing with the previous example, for a user comment that states: “I modified the recipe to use brown sugar instead,” the cognitive assistance component of the variant generating program 110a, 110b identifies that a substitution was made with brown sugar. The cognitive assistance component determines, based on the given ingredients in the original recipe and the internal knowledge stored in the knowledge database 210, that white sugar is the common replacement for brown sugar. As such, the cognitive assistance component generates the appropriate substitution recipe using the substitution ratios learned from the internal knowledge stored in the knowledge database 210.

According to one embodiment, the cognitive assistance component of the variant generating program 110a, 110b may determine ingredient additions, based on comprehension of the original instructional guide, the modifications determined from the user comments feed, and the internal knowledge stored in the knowledge database 210.

Continuing with the previous example, a user comment for a pancake recipe states: “I added chocolate chips to the recipe.” In order to generate this variant recipe, the cognitive assistance component accesses the internal knowledge stored in the knowledge database 210 and learns a ratio of the chocolate chips quantity with an existing ingredient or ingredients in the original recipe, such as the flour quantity. Based on the internal knowledge stored in the knowledge database 210, the cognitive assistance component generates a variant recipe including an estimate of the chocolate chips quantity that should be added relative to the flour quantity.

According to another embodiment, the cognitive assistance component of the variant generating program 110a, 110b may determine cooking times and methods, based on comprehension of the original instructional guide, the modifications determined from the user comments feed, and the internal knowledge stored in the knowledge database 210.

For example, an original recipe for baked chicken requires the chicken to be cooked at 400 degrees for 30 minutes. A user comment for the baked chicken recipe states: “I thought the chicken was a bit dry for my taste. I made a juicer version cooking the chicken at 375 instead.” Based on the user comment and the cooking heat/time ratios that the cognitive assistance component learns by accessing the internal knowledge stored in the knowledge database 210, the cognitive assistance component generates a variant recipe that requires the chicken to be cooked at 375 degrees and changes the cook time from 30 minutes to 45 minutes.

According to another embodiment, the cognitive assistance component of the variant generating program 110a, 110b may determine the serving size and ingredient/cooking time ratios, based on comprehension of the original instructional guide, the modifications determined from the user comments feed, and the internal knowledge stored in the knowledge database 210.

Continuing with the previous example, an original recipe is provided for four servings. A user comment for the original recipe states: “The recipe was great, but it was too much for me. I made a single serving version by cutting the ingredients in half. I had to add a half cup of water and reduced the cooking time by fifteen minutes.” Since cooking methods may vary for different serving sizes, depending on the volume and mix of ingredients, the cognitive assistance component learns the cooking methods and correct ratios from the internal knowledge stored in the knowledge database 210. Thereafter, the cognitive assistance component generates a variant recipe for a single serving of the original recipe.

Then, at 218, a variant instructional guide is displayed. In one embodiment, the variant generating program 110a, 110b may return the variant instructional guide to the webpage in a stand-alone format (e.g., a floating text box or new webpage separate from the webpage displaying the original instructional guide). In another embodiment, the variant generating program 110a, 110b may provide the variant instructional guide in a side-by-side comparison format with the original instructional guide on the same webpage. In at least one embodiment, the variant generating program 110a, 110b may provide the variant instructional guide as an overlay, indicating the changes to the original instructional guide. In another embodiment, the variant generating program 110a, 110b may provide the variant instructional guide with a hyperlink for directing the end-user to the underlying user comments related to the modifications to the instructional guide. Thereafter, the webpage may transmit (e.g., via communication network 116) the variant instructional guide for display on the user device.

Continuing with the previous example, the variant generating program 110a, 110b generates a less sweet variant of a pancake recipe which requires a half cup of brown sugar instead of one cup of white sugar. Thereafter, the variant generating program 110a, 110b provides an overlay text stating: “For a less sweet recipe, substitute the white sugar with a half cup of brown sugar,” adjacent the step in the original recipe calling for the one cup of white sugar. The variant generating program 110a, 110b also includes a hyperlink in the overlaid text for directing the end-user to the underlying user comment. Thereafter, the cooking webpage transmits, via communication network 116, the variant recipe for display on the user laptop.

According to one embodiment, the variant generating program 110a, 110b may provide a nutrition profile associated with the variant instructional guide. The variant generating program 110a, 110b may determine the nutrition profile by accessing a nutrition-related repository stored in the knowledge database 210. Continuing with the previous example, the variant generating program 110a, 110b accesses the nutrition-related repository stored in the knowledge database 210 and retrieves the updated nutrition profile associated with using a half cup of brown sugar in the pancake recipe. The variant generating program 110a, 110b provides the updated nutrition profile in a floating text box adjacent the variant recipe.

In at least one embodiment, the variant generating program 110a, 110b may migrate a rating of the user comment underlying the variant instructional guide and may provide the migrated rating as a corresponding rating for the variant instructional guide generated from the user comment. Continuing with the previous example, the variant generating program 110a, 110b retrieves the four-star rating provided by the second user comment underlying the variant recipe and provides the four-star rating in a floating text box adjacent the variant recipe.

The following described exemplary embodiments provide a system, method and program product for generating instructional variants for an instructional guide based on natural language processing of a user comments feed. As such, the present embodiment has the capacity to improve the technical field of cognitive computing by crowd-sourcing modifications to an instructional guide (e.g., a recipe) based on natural language processing of the user comments and generating instructional variants for the instructional guide based on the crowd-sourced information.

As described herein, the variant generating program 110a, 110b may have the capacity to improve the technical field of cognitive computing by providing an end-user with crowd-sourced modifications to an instructional guide. The variant generating program 110a, 110b may enable natural language processing of the user comments feed associated with the instructional guide in order to determine the instructional modifications included in the user comments. The variant generating program 110a, 110b may also provide a knowledge database 210 which may be accessed by a cognitive assistance component to learn additional information for generating the variant instructional guide. The variant generating program 110a, 110b may provide a user-friendly interface which may serve as a central reference for the end-user to learn from both the original instructional guide as well as the variant instructional guide. As such, the end-user may learn from the experiences of the previous users, without the time-consuming process of reading through the user comments feed. Thus, the variant generating program 110a, 110b may improve the functionality of a computer.

It may be appreciated that FIG. 2 provides only an illustration of one embodiment and does not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 3. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108 and the variant generating program 110a in client computer 102, and the variant generating program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the variant generating program 110a, 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the variant generating program 110a in client computer 102 and the variant generating program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the variant generating program 110a in client computer 102 and the variant generating program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

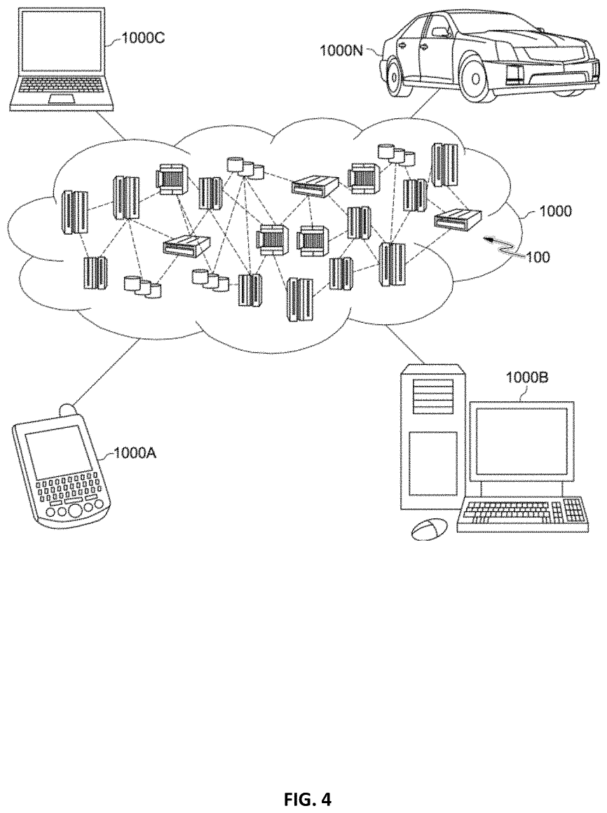

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

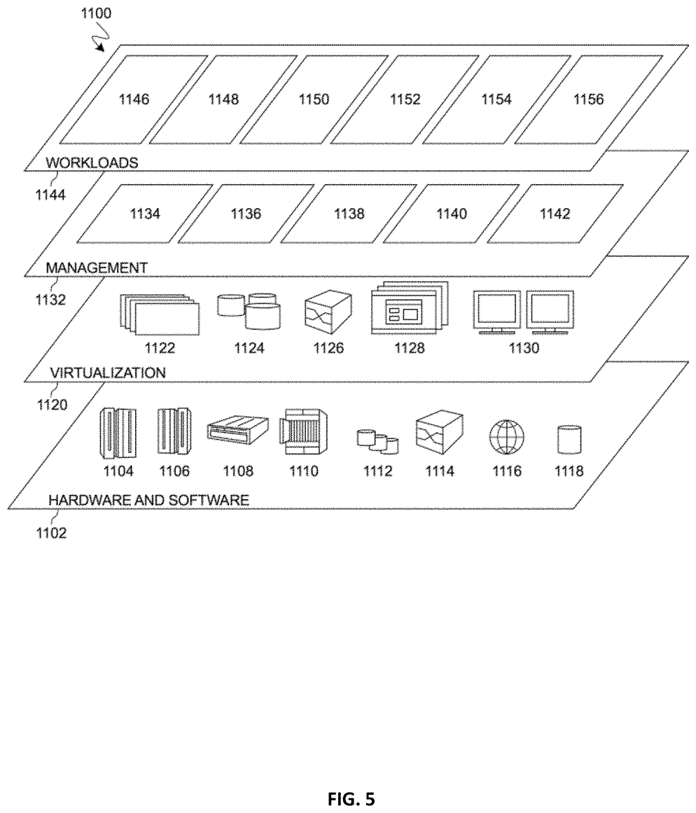

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and variant generation 1156. A variant generating program 110a, 110b provides a way to generate variants to an instructional guide based on natural language processing of user comments pertaining to the instructional guide.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for generating an instructional variant, the method comprising:
identifying an instructional guide;
analyzing a user comments feed associated with the identified instructional guide; and
in response to determining that the analyzed user comments feed includes a modification to the identified instructional guide, generating a variant instructional guide including the modification to the identified instructional guide.

2. The method of claim 1, further comprising:
providing a webpage including the identified instructional guide;
extracting the analyzed user comments feed from the provided webpage including the identified instructional guide;
storing the extracted user comments feed in a comments database; and
performing a natural language processing of the stored user comments feed.

3. The method of claim 1, further comprising:
determining, in the identified instructional guide, a recipe including a first ingredient;
determining, in the analyzed user comments feed, a second ingredient substituting for the included first ingredient in the determined recipe; and
generating a variant recipe including the determined second ingredient substituting for the included first ingredient in the determined recipe.

4. The method of claim 1, further comprising:
determining, in the identified instructional guide, a recipe including a first quantity of a first ingredient;
determining, in the analyzed user comments feed, a second ingredient substituting for the included first ingredient in the determined recipe;
learning a substitution quantity ratio between the included first ingredient in the determined recipe and the determined second ingredient in the determined user comments feed;
determining, based on the learned substitution quantity ratio, a second quantity of the determined second ingredient for substitution with the included first quantity of the included first ingredient; and
generating a variant recipe including the determined second quantity of the determined second ingredient substituting for the included first quantity of the included first ingredient in the determined recipe.

5. The method of claim 1, further comprising:
processing the identified instructional guide;
determining at least one target for identification in the analyzed user comments feed, wherein the determined at least one target is associated with the processed instructional guide; and
storing the determined at least one target in a knowledge database.

6. The method of claim 2, further comprising:
displaying the identified instructional guide in the provided webpage;
displaying the generated variant instructional guide in the provided webpage; and
positioning the displayed instructional guide side-by-side with the displayed variant instructional guide.

7. The method of claim 5, wherein analyzing the user comments feed further comprises:
extracting at least one keyword from the analyzed user comments feed;
comparing the extracted at least one keyword from the analyzed user comments feed with the stored at least one target in the knowledge database; and
in response to identifying the stored at least one target in the extracted at least one keyword from the analyzed user comments feed, determining that the analyzed user comments feed includes the modification to the processed instructional guide.

8. A computer system for generating an instructional variant, comprising:
one or more processors, one or more computer-readable memories, one or more computer-readable tangible storage media, and program instructions stored on at least one of the one or more computer-readable tangible storage media for execution by at least one of the one or more processors via at least one of the one or more memories, wherein the computer system is capable of performing a method comprising:
identifying an instructional guide;
analyzing a user comments feed associated with the identified instructional guide; and
in response to determining that the analyzed user comments feed includes a modification to the identified instructional guide, generating a variant instructional guide including the modification to the identified instructional guide.

9. The computer system of claim 8, further comprising:
providing a webpage including the identified instructional guide;
extracting the analyzed user comments feed from the provided webpage including the identified instructional guide;
storing the extracted user comments feed in a comments database; and
performing a natural language processing of the stored user comments feed.

10. The computer system of claim 8, further comprising:
determining, in the identified instructional guide, a recipe including a first ingredient;
determining, in the analyzed user comments feed, a second ingredient substituting for the included first ingredient in the determined recipe; and
generating a variant recipe including the determined second ingredient substituting for the included first ingredient in the determined recipe.

11. The computer system of claim 8, further comprising:
determining, in the identified instructional guide, a recipe including a first quantity of a first ingredient;
determining, in the analyzed user comments feed, a second ingredient substituting for the included first ingredient in the determined recipe;
learning a substitution quantity ratio between the included first ingredient in the determined recipe and the determined second ingredient in the determined user comments feed;
determining, based on the learned substitution quantity ratio, a second quantity of the determined second ingredient for substitution with the included first quantity of the included first ingredient; and
generating a variant recipe including the determined second quantity of the determined second ingredient substituting for the included first quantity of the included first ingredient in the determined recipe.

12. The computer system of claim 8, further comprising:
processing the identified instructional guide;
determining at least one target for identification in the analyzed user comments feed, wherein the determined at least one target is associated with the processed instructional guide; and
storing the determined at least one target in a knowledge database.

13. The computer system of claim 9, further comprising:
displaying the identified instructional guide in the provided webpage;
displaying the generated variant instructional guide in the provided webpage; and
positioning the displayed instructional guide side-by-side with the displayed variant instructional guide.

14. The computer system of claim 12, wherein analyzing the user comments feed further comprises:
extracting at least one keyword from the analyzed user comments feed;
comparing the extracted at least one keyword from the analyzed user comments feed with the stored at least one target in the knowledge database; and
in response to identifying the stored at least one target in the extracted at least one keyword from the analyzed user comments feed, determining that the analyzed user comments feed includes the modification to the processed instructional guide.

15. A computer program product for generating an instructional variant, comprising:
one or more computer-readable tangible storage media and program instructions stored on at least one of the one or more computer-readable tangible storage media, the program instructions executable by a processor to cause the processor to perform a method comprising:
identifying an instructional guide;
analyzing a user comments feed associated with the identified instructional guide; and
in response to determining that the analyzed user comments feed includes a modification to the identified instructional guide, generating a variant instructional guide including the modification to the identified instructional guide.

16. The computer program product of claim 15, further comprising:
providing a webpage including the identified instructional guide;
extracting the analyzed user comments feed from the provided webpage including the identified instructional guide;
storing the extracted user comments feed in a comments database; and
performing a natural language processing of the stored user comments feed.

17. The computer program product of claim 15, further comprising:
determining, in the identified instructional guide, a recipe including a first ingredient;
determining, in the analyzed user comments feed, a second ingredient substituting for the included first ingredient in the determined recipe; and
generating a variant recipe including the determined second ingredient substituting for the included first ingredient in the determined recipe.

18. The computer program product of claim 15, further comprising:
determining, in the identified instructional guide, a recipe including a first quantity of a first ingredient;
determining, in the analyzed user comments feed, a second ingredient substituting for the included first ingredient in the determined recipe;
learning a substitution quantity ratio between the included first ingredient in the determined recipe and the determined second ingredient in the determined user comments feed;
determining, based on the learned substitution quantity ratio, a second quantity of the determined second ingredient for substitution with the included first quantity of the included first ingredient; and
generating a variant recipe including the determined second quantity of the determined second ingredient substituting for the included first quantity of the included first ingredient in the determined recipe.

19. The computer program product of claim 15, further comprising:
processing the identified instructional guide;
determining at least one target for identification in the analyzed user comments feed, wherein the determined at least one target is associated with the processed instructional guide; and
storing the determined at least one target in a knowledge database.

20. The computer program product of claim 16, further comprising:
displaying the identified instructional guide in the provided webpage;
displaying the generated variant instructional guide in the provided webpage; and
positioning the displayed instructional guide side-by-side with the displayed variant instructional guide.
